(19) United States
(12) Patent Application Publication
(10) Pub. No.: US 2005/0039110 A1
(43) Pub. Date: Feb. 17, 2005

(54) Methodology and graphical user interface to visualize genomic information

(76) Inventors: Francisco M. De La Vega, San Mateo, CA (US); Hadar I. Isaac, Los Altos, CA (US)

Correspondence Address: HARNESS, DICKEY & PIERCE, P.L.C., P.O. BOX 828, BLOOMFIELD HILLS, MI, 48303, US

(21) Appl. No.: 10/833,000

(22) Filed: Apr. 28, 2004

Related U.S. Application Data
(60) Provisional application No. 60/466,310, filed on Apr. 28, 2003.

(51) Int. Cl. G06F 17/21

(52) U.S. Cl. 715/500

(57) ABSTRACT

A method for displaying genomic information includes displaying a first axis representing a chromosome with units of basepairs. It also includes displaying on the first axis first and second sets of gene reference marks identifying genes located on forward and reverse strands of the chromosome. One or more sets of additional reference marks are further displayed, including genetic marker reference marks and haplotype reference marks. Each set of haplotype reference marks identifies one or more haplotype blocks for a population.

### CROSS-REFERENCE TO RELATED APPLICATIONS

This application claims the benefit of U.S. Provisional Application No. 60/466,310, filed on Apr. 28, 2003. The disclosure of the above application is incorporated herein by reference.

### FIELD

The present innovation relates to systems and methods for communicating genomic information, and particular relates to a methodology and graphic user interface for visualizing genomic information.

### BACKGROUND

While it is understood that environment, diet, age, lifestyle, and general health can all play a role in an individual's response to medication, it is widely believed that an individual's genetic makeup is the key to creating personalized efficacious and safe medications. At the intersection of pharmacology and genomics lies the field of pharmacogenomics. This field is the study of how an individual's genetic inheritance affects drug response and holds the promise that drugs may be tailor made for individuals and fine tuned for their specific genetic makeup. In order achieve this goal, pharmacogenomics combines biochemistry and other traditional pharmaceutical sciences with annotated knowledge of genes, proteins, and single nucleotide polymorphisms. Single nucleotide polymorphisms are believed to play a particularly important role in understanding etiologies of disease. Pharmacogenomics has the potential to dramatically reduce the estimated 100,000 deaths and 2 million hospitalizations that occur each year in the United States as the result of adverse drug response as discussed in J. Lazarou, B. H. Pomeranz, and P. N. Corey. Incidence of adverse drug reactions in hospitalized patients: a meta-analysis of prospective studies. JAMA. Apr 15, 1998. 279(15):1200-5. It also promises more powerful medications, advance screening for disease susceptibility, the development of new and powerful vaccines, improvements in drug discovery and approval process and decreased cost for health care.

An example of the benefits of pharmacogenomics is the understanding of the DNA variations in the cytochrome P450 (CYP) family of liver enzymes, which are responsible for breaking down more than 30 different classes of drugs. Less active forms of these enzymes can result in poor metabolism of drugs and inefficient elimination from the body, which in turn can lead to drug overdose.

Another example is an enzyme called TPMT (thiopurine methyltransferase), which plays an important role the breakdown of a class of therapeutics called thiopurines. Thiopurines are commonly used in chemotherapy treatment of common childhood leukemia. A small percentage of Caucasians have genetic variants that prevent them from producing an active form of this protein. As a result, thiopurines elevate to toxic levels in the patient because the inactive form of TMPT is unable to break down the drug. Today, doctors can use a genetic test to screen patients for this deficiency, and the TMPT activity is monitored to determine appropriate thiopurine dosage levels as discussed in S. Pistoi. Facing your genetic destiny, part II. Scientific American. Feb. 25, 2002.

One of the recognized problems in the field of pharmacogenomics is discovery of the complex gene variations that affect drug response. The design of studies to find single nucleotide polymorphisms is tedious and as SNPs occur every 100 to 300 bases along the 3-billion-base human genome. Thus millions of SNPs must be identified and analyzed to determine their involvement in drug response. This pharmacogenomics problem is further compounded by the need to understand which genes are involved in disease, thus the big picture requires understanding the complex interplay of genetic modifications that affect disease and the genetic modifications that affect the efficacy of drugs. The process of designing studies to understand this interplay is both time consuming and costly.

What is needed is a way to assist researchers in the process of designing such studies. The present teachings can fulfill this need.

### SUMMARY

In accordance with the present innovation, a method for displaying genomic information includes displaying a first axis representing a chromosome with units of basepairs. It also includes displaying on the first axis first and second sets of gene reference marks identifying genes located on forward and reverse strands of the chromosome. One or more sets of additional reference marks are further displayed, including genetic marker reference marks and haplotype reference marks. Each set of haplotype reference marks identifies one or more haplotype blocks for a population.

The method for visualizing genomic information and graphic user interface implementing the method is advantageous over previous viewing systems and methods in several ways. For example, the sets of gene reference marks can indicate intron and exon regions for one of more genes in the set. Also, the exon regions can be encoded with prediction power information for one or more populations that can be calculated via a statistical model. Further, the first linear axis displaying the chromosome in basepair units can be visually related to a nonlinear axis in LD units for a selected population. Yet further, the gene reference marks can be single-nucleotide polymorphisms. Further still, the navigation mechanism provided in an online browser format with complimentary controls can permit the user to select a chromosome for display and/or navigate the chromosome and its displayed SNPs and Haplotypes with name search and/or pan and zoom functionality. Yet further still, the user may be permitted to automatically query an online ordering system for assays by navigating the genomic data to a point of interest and selecting single-nucleotide polymorphisms.

Further areas of applicability of the disclosed methods will become apparent from the detailed description provided hereinafter. It should be understood that the detailed description and specific examples, while indicating various embodiments, are intended for purposes of illustration only and are not intended to limit the scope of the innovation.

### BRIEF DESCRIPTION OF THE DRAWINGS

The present innovation will become more fully understood from the detailed description and the accompanying drawings, wherein:

FIG. 1 is an Assays-on-Demand™ SNP Genotyping Products development and validation workflow;

FIG. 2 is a graph illustrating distribution of the minor allele frequency of validated SNPs in each population studied;

FIG. 3 is an exemplary visualization of the distribution of Assays-on-Demand™ SNP Genotyping Products across a region of chromosome 6;

FIG. 4 is an exemplary visualization of an on-line catalog, search, and ordering interface for the Assays-on-Demand™ SNP Genotyping Products available at the Applied Biosystems on-line store;

FIG. 5 is a graph illustrating concordance between different haplotype block finding methods;

FIGS. 6A, 6B, and 6B are LD maps of chromosomes 22, 21, and 6 for the African-American and Caucasian populations;

FIG. 7 is a graph illustrating distribution of cumulative average power per gene, calculated for a fixed sample size of 500 cases and 500 controls; and

FIGS. 8-15 are views of the graphic user interface and complimentary visualization methodology according to the present innovation.

### DETAILED DESCRIPTION

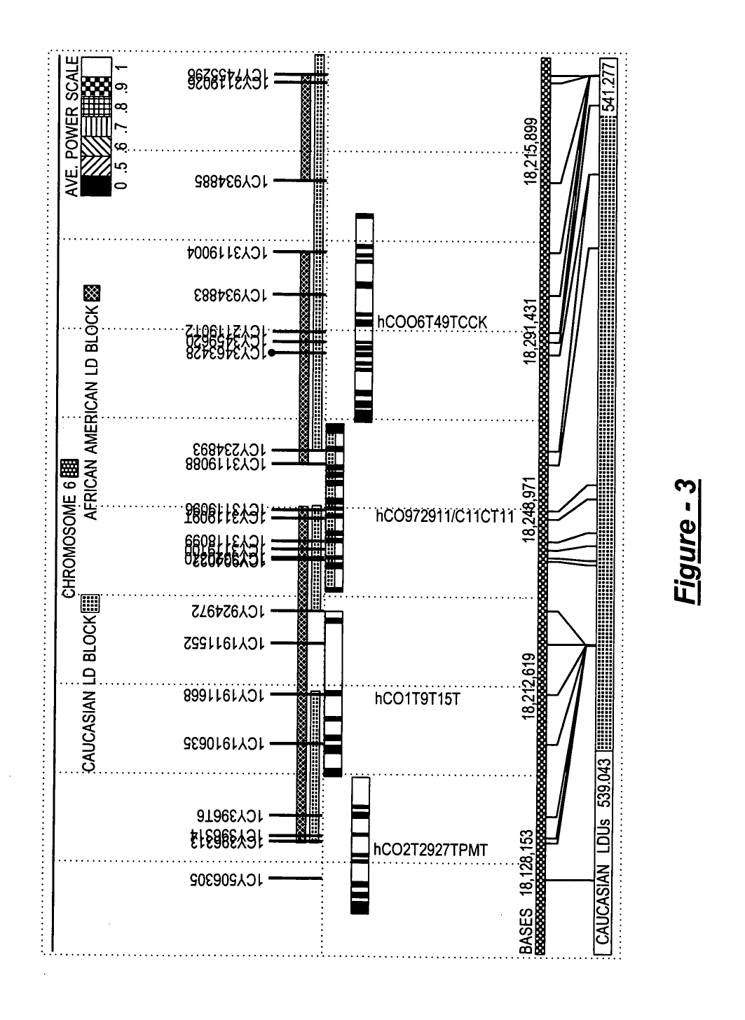

The following description is merely exemplary in nature and is in no way intended to limit the methods, their application, or uses. Before proceeding to description of the visualization technique and graphic user interface with reference to FIGS. 3 and 8-15, it is helpful to discuss the development of the genomic data to be visualized, navigated, and selected in accordance with the present teachings. Accordingly, by way of overview, development of SNP assays and identification of population-related Haplotype regions is first discussed below. In accordance with the present teachings, a genome information visualization technique is developed in part based on efforts related to providing a whole-genome linkage disequilibrium SNP map and validated assay resource. A set of 5′ nuclease allelic discrimination assays have been developed to score single nucleotide polymorphisms (SNPs) with the aim of creating a reference map for use in candidate-gene, candidate region and whole-genome linkage disequilibrium (LD) mapping studies. The assays were validated by individually genotyping 90 DNA samples, 45 from African-American and 45 from Caucasian individuals, selected from the Coriell Human variation collection. Candidate SNPs were prioritized from the Celera RefSNP database which contains 4 million unique SNPs from combined Celera and Public SNP databases through a triage process that requires evidence of independent discovery of the minor allele. SNPs were selected on 27,007 Celera gene predictions, in a gene focused picket-fence with an average density of one SNP per 10 kb of gene length, including 10 kb upstream and downstream of the predicted gene boundaries. PCR primers and TaqMan® (available from Applied Biosystems) probes for the 5′ nuclease assays were then designed by a software pipeline that picks oligonucleotide sequences and then screens the assays against the genome database for identifying artifacts, which can be, for example, incorrect nucleotide insertion. Following genotyping 90 individuals, the performance of each assay was benchmarked against stringent criteria for background signal, adequate signal generation, and specificity. Validation results showed that 94% of the SNPs tested in the population panels were polymorphic and about 90% of the assays passed stringent performance criteria. Of those, 87% have minor allele frequencies >=0.05 in Caucasian panel and 88% in African-American samples. These figures represent an extremely high SNP validation rate, and an unprecedented yield of common SNPs useful in LD mapping. Allele frequency data in the populations tested can be made available with the assays. The individual genotypes being generated can enable identification of blocks of LD and haplotype diversity across all gene regions of the genome for these populations. This information can be used to refine the SNP set coverage.Applied Biosystems has developed a set of TaqMan® probe-based (5′ nuclease) assays to score single nucleotide polymorphisms (SNPs). These assays can be used to create a reference map for use in candidate region, candidate-gene, and whole-genome association studies by linkage disequilibrium (LD) mapping. Such a set of ready to use assays can provide high-density coverage of known gene regions to facilitate easier and more affordable genetic studies, yielding genotyping answers more quickly than conventional methods. In some embodiments, the assays are manufactured, functionally QC tested, and validated by individually genotyping 180 DNA samples selected from four major populations in a high-throughput genotyping services facility before being put in inventory. The resulting allele frequency data is made available on the web to help in the selection of the assays. Referring to FIG. 1, the method for developing and validating the assays includes SNP selection for a linkage disequilibrium marker set from a set of SNPs that occur within genes or in regions close to genes. (this seems out of place) Currently, the gene list used includes 26,730 gene regions derived by Celera Genomics, their boundaries expanded by 10 kb up- and downstream to account for regulatory regions and undiscovered exons and UTRs. The candidate SNPs were selected from the Celera Human RefSNP database (version 3.6) through a “triage” process that requires evidence of independent discovery of the minor allele. First, over 1 million SNPs were culled with increased likelihood of having high heterozygosity from a starting set of more than 4.1 million genomically mapped public and Celera-discovered SNPs at step 100. This initial selection required multiple independent observations of a SNP's minor allele. Custom queries were derived to the RefSNP database to identify SNPs discovered both by Celera and by the public SNP discovery efforts. In addition, SNPs were selected whose minor alleles were observed in at least two distinct donors of the Celera shotgun sequencing of the human genome. Finally, single-donor Celera SNPs were compared to the public genomic assembly to find cases where the Celera minor allele was confirmed in the public consensus sequence. The method also includes SNP Assay Development. In the second major step 102 of the strategy, PCR primers and TaqMan® probes can be designed by an algorithm pipeline which selects oligonucleotide sequences. These primer and probe designs can the be screened against the genome database as a computational QC step for potential artifacts at step 104. 5′ nuclease assays that passed the previous step can then be subjected to further selection criteria such as, but not limited to being in or within 10 kb of a gene region; and/or being optimally spaced to provide at least 3 SNPs per gene with a maximal inter-SNP physical distance of 10 kb. Finally, remaining gaps can be filled in gene regions with some number, (for example 2) unscreened SNPs per 10 kb to take into account an expected 50% rate of validation of these lower quality SNPs.

After the primers and probes were synthesized in the high-throughput manufacturing facility, quality-control steps can be implemented. For example, oligonucleotide integrity can be tested and assay performance can be tested against a panel of 10 individual genomic DNA samples. Only assays that pass QC tests at step 106 are moved on for validation in the population panels at step 108, which can include DNA samples from some number African-American, Caucasian (from the Coriell Institute/NIGMS Human Variation panels), Chinese, and Japanese individuals. Some embodiments use 45 individuals from each population. Assay validation in population samples can help ensure that the locus is polymorphic and that the allele frequency will be adequate for association studies in a variety of populations. The performance of each assay can be benchmarked at step 110 against several criteria. Examples of such criteria are background signal, adequate signal generation, and specificity. Assays that meet performance criteria and some minimum minor allele frequency (for example 5%) at step 112 in either of the populations tested are annotated at step 114 and released for sale at step 116 at the Applied Biosystems on-line store.

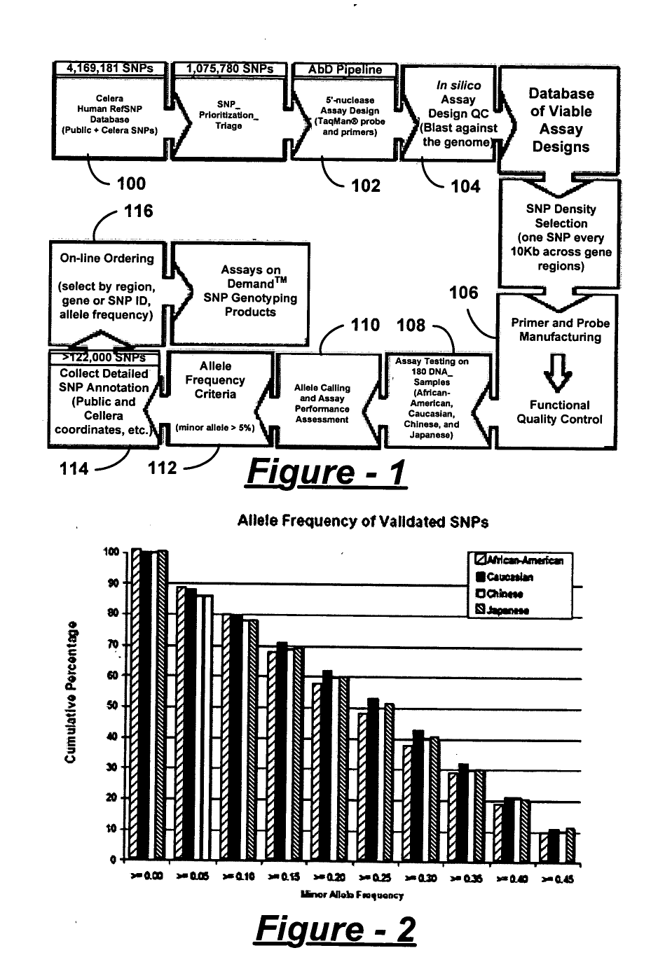

Assay validation yield results have demonstrated that the SNP selection “triage” procedure can be effective in prioritizing SNPs with higher likelihood of being highly polymorphic in multiple populations. For example, in 258,260 assays validated on African-American and Caucasian populations, approximately 95% of the 122,287 SNPs assays that passed the performance criteria described above were polymorphic. As shown in FIG. 2, 88% of the polymorphisms have a minor allele frequency ≧5% in the African-American or Caucasian panels. Additionally, allele frequency information has been obtained on >67,000 assays on both Chinese and Japanese population samples, showing that 90% of assays for one or the other population have a minor allele frequency of ≧5%, and a very considerable overlap of common SNPs between all 4 different populations tested. It is anticipated that this frequency and overlap will be preserved when all assays have been genotyped in the Asian population panels. These figures represent an extremely high SNP validation rate, and an unprecedented yield of common SNPs useful in LD mapping.

Analysis of genotype data from reference samples is now described. The individual genotypes of the DNA samples generated during validation have enabled study of the profile of linkage disequilibrium across gene regions of the genome for these populations. Methods have been applied to identify haplotype blocks, regions of strong LD and low haplotype diversity, and locations with statistical power for finding association. In addition, metric maps can be constructed that are scaled to the strength of LD and can guide the selection of SNPs for association studies independent of block boundaries (cf. Maniatis et al., PNAS 99: 2228-33, 2002). Ultimately, one of the metrics of greatest practical utility will relate to the power of detecting an association between a disease or disease-risk phenotype and SNPs marker in that region. Empirical data can provide an opportunity to estimate the power of a LD SNP map for a large number of known genes. These power estimations can be used to design a genetic study by selecting the adequate number of markers and sample size.

Turning to FIG. 3, an exemplary visualization of the distribution of Assays-on-Demand™ SNP Genotyping Products across a region of chromosome 6 has different display properties provided to different gene markers. Validated SNPs are indicated by vertical lines with Celera identifiers, and gene regions as horizontal rectangles, with Celera identifiers and HUGO names indicated below, and exons darkly colored. In some embodiments, different colors are used as display properties. However, colors are replaced by black and white patterns in FIG. 3 for purposes of illustration. Horizontal bars represent haplotype blocks calculated for the African-American (Red) and Caucasian populations. Gene regions are represented in a scale representing the results of power calculations for a fixed sample size of 500 cases and 500 controls, an assumed disease allele frequency of 0.2, and a multiplicative gene model typical of the common variant/common disease hypothesis. In some embodiments, the bivalent spectrum of the scale observes a convention of spectral color shift across the spectrum, rather than the black and white patterns included merely for purposes of illustration. Axes indicate the physical scale in base-pairs, and the metric linkage disequilibrium units scale calculated with the LDMAP software of Maniatis et al. (PNAS 99: 2228-33, 2002) for Caucasians and African-Americans.

In the present example, the panel shows a section of chromosome 6. In some embodiments according to this example, vertical blue bars indicate SNPs, and horizontal red bars are haplotype blocks (African American), while horizontal yellow bars are haplotype blocks (Caucasian). Genes on the forward strand (magenta are introns), while genes on the reverse strand (magenta are introns). The first axis in basepairs (a linear scale) is visually related to a second axis in Linkage Disequilibrium Units (a nonlinear scale) by blue lines that indicate SNPs and location of the two axes. Gene bars are also color-coded to display prediction power based on linkage disequilibrium (bottom is Caucasian, top is African American). A power legend is in the upper right hand corner.

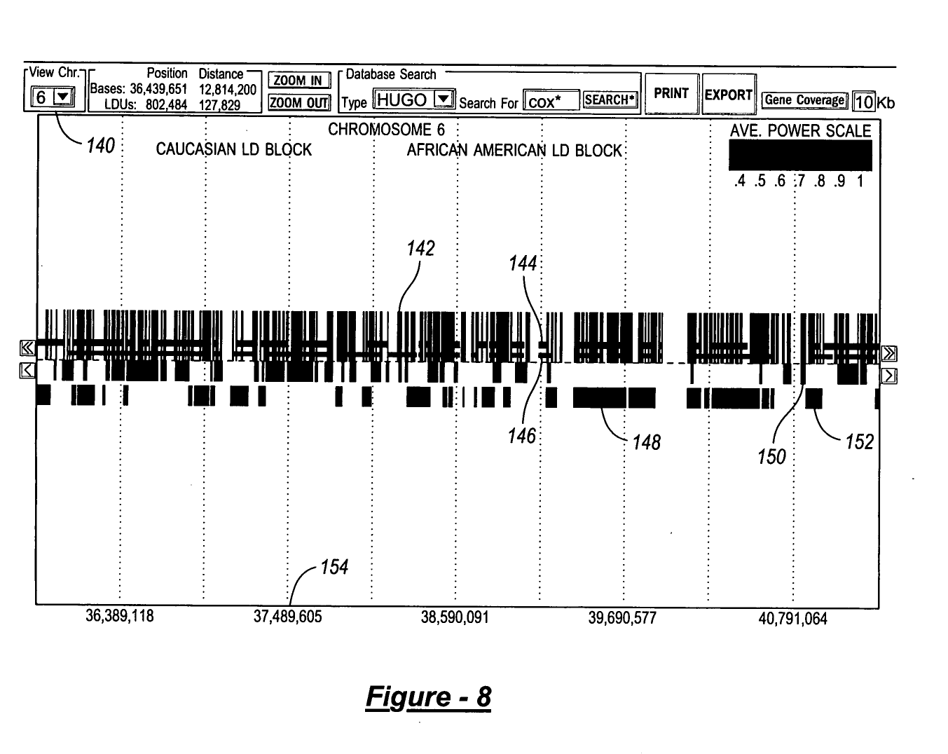

Using the empirical data, parsimonious subsets of SNPs (“tagging” SNPs) can be identified that have adequate power in disease association studies. This can greatly reduce the study time and cost. Furthermore, the data can allow the identification of regions where, due to the low LD, additional and complementary SNPs currently not in the validated set are needed. These custom assays can be ordered through from a service which employs the same design algorithm. For example, the Assays-by-Design™ service from Applied Biosystems is such a service. According to the present teachings, one or more graphic user interfaces can be used to allow researchers to access the analyses of the reference data obtained in order to help them select SNPs for their studies. FIG. 3 illustrates major components of an embodiment of such a graphic user interface. It is described in greater detail below with reference to FIGS. 8-15. It is envisioned that this information can allow association studies to be designed more rationally according to the specific population and region of the genome under study, by permitting determination of which genes may require more SNP coverage and/or a larger sample size.

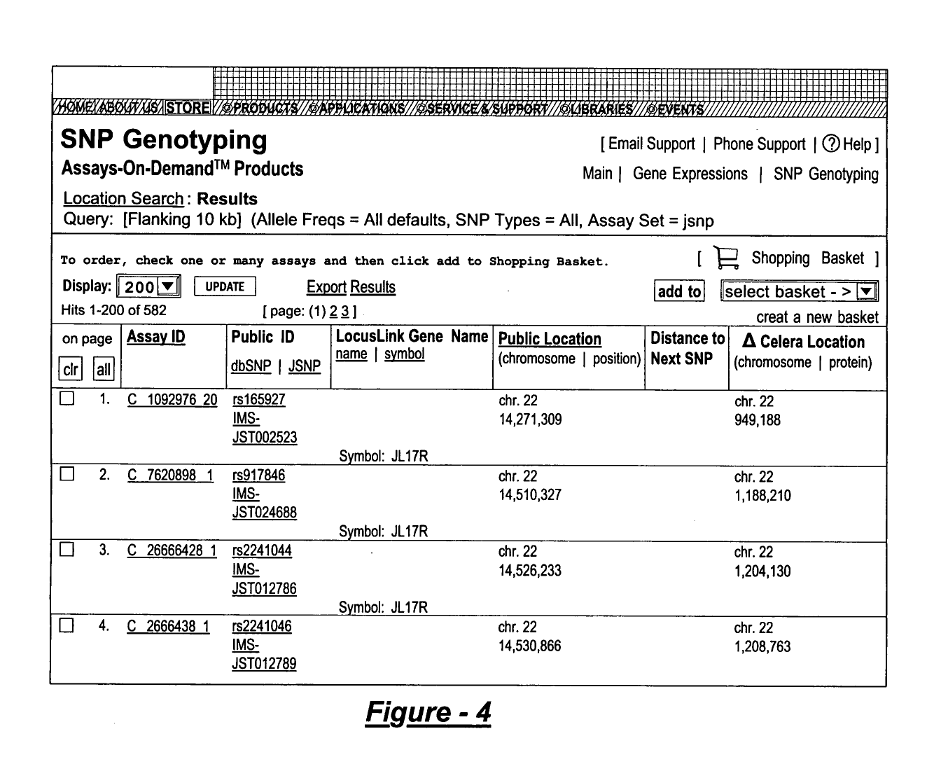

Assays developed according to the method described above are commercially available and may be purchased via an online store as pictured in FIG. 4. For example, approximately 130,000 were released in the first half of 2003 through the Applied Biosystems on-line store (http://store.appliedbiosvstems.com). This assay resource is searchable by a number of annotations. For example, researchers who know the exact SNPs they want can search using the appropriate identifiers (e.g., Celera variation ID, dbSNP rs or ss ID). Users can also research SNPs by gene name (e.g., HUGO gene symbol, RefSeq ID, Celera transcript ID), or by location within a particular chromosomal interval (using coordinates from either the public or the Celera genome assembly) or reference marker range (e.g., microsatellite, cytoband) they are interested in. Within these regions, the user can specify filtering criteria based on population allele frequency, SNP type (e.g., intronic, coding), a user-specified flanking region, or gene overlap. Once selected, the assays can be easily ordered directly on-line. Together with their assay order, researchers receive a CD-ROM with an assay information file that enables them to set-up the assay (e.g., detection instrumentation parameters), and fully integrate the SNP into their studies (e.g., context sequence, chromosomal coordinates, allele-dye key, allele frequency, etc). One skilled in the art will appreciate that other naming conventions or filtering criteria can be added to an online store to further facilitate searching and sorting of SNPs.

As described above, a high-quality LD map of validated SNPs can be created by integrating information from both public and private human genome efforts. Expertise in assay design and bioinformatics can allow development of a set of validated SNPs and ready-to-use assay reagents for use with an easy workflow. The individual genotypes being generated can enable a survey of the magnitude of LD and the haplotype diversity across gene regions of the genome for these populations. This survey allows identification of regions that will require higher or lower SNP density to further optimize the map.

In order to further describe the development of the genomic information visualized according to the present teachings, a comparative study is presented of the patterns of linkage disequilibrium (LD) across three human autosomes: chromosomes 6, 21, and 22. A total of 19,860 SNPs with a median spacing ranging from 4 to 7 kb, covering more than 193 Mb of chromosomal segments, and overlapping 2,266 predicted gene regions, were genotyped in 45 African-American and 45 Caucasian DNA samples from the Coriell Institute. Levels of LD potentially useful for mapping extended 30-57% longer for Caucasians as compared to African-Americans, whereas chromosome 6 showed about 50% more extensive LD than the shorter chromosomes (21 and 22). Several methods were applied to find haplotype blocks, optimizing for a minimum number of blocks. However, for a given method multiple optimal solutions were obtained, and while overlapping, they differ up to 37% in the location of boundaries. When comparing different methods, the differences in shared boundaries are more dramatic, although again significant overlap exists. When an optimal solution of the D′-based method was selected, haplotype blocks mean length ranged from 29 to 51 Kb and were on average 33-42% larger in the Caucasian population than in the African-American population, and 60% larger in chromosome 6 than in chromosomes 21 and 22. The blocks found in African-Americans overlap 70% in length with the Caucasian blocks, whereas the reverse is only about 50%, largely due to Caucasian-specific block segments. In the overlapped block segments, 70% of the common haplotypes are shared between the populations, but 21% are exclusive to African-Americans, and only 8.5% are Caucasian unique. It was found that, even when up to 93% of the typed SNPs can be found participating in blocks of at least two SNPs, these blocks cover only 31-49% of the length of the chromosomal segments studied. Utilizing previously developed theory for metric LD maps, population-specific LD maps were produced for the three chromosomes, that when plotted against physical distance, show plateaus of strong LD and steps of high recombination. The total number of LD units in the maps was 35% longer in African-Americas than in Caucasians. LD was highly correlated to recombination rates estimated from high-resolution linkage maps, and to a lesser extent to SNP density and GC content. Finally, the average statistical power to find association on a per gene basis was estimated using the current SNP map, under reasonable assumptions for complex disease. The results suggest that an average power of over 0.8 for a sample of 500 cases and 500 controls can be obtained for at least 60% of the genes studied when the disease allele frequency is 0.1, and up to 93% when the frequency is 0.2. Together, these results point out areas and genes where additional SNPs would be required for finer coverage and definition of the LD patterns, but suggest that the current SNP density might provide an acceptable starting point to perform association studies and more exhaustive haplotype maps.

Recently, there has been tremendous interest in empirically establishing the patterns of allelic association, also known as linkage disequilibrium (LD), among polymorphic variants of the human genome. When two alleles at adjacent loci co-occur in a chromosomal segment more often than expected if they were segregating independently in the population, the loci are in linkage disequilibrium. The extent of LD across genomic regions is a useful parameter for defining the statistical power of association studies utilizing single-nucleotide polymorphisms (SNP) as surrogate genetic markers, and for guiding the selection and spacing of such polymorphisms to create a marker map useful in candidate gene, candidate region, and eventually whole-genome association studies.

With the aim of developing a SNP map to serve as a resource for candidate-gene and candidate-region association studies, SNPs with a median spacing of less than 7 kb covering most of the length of three human autosomes: chromosomes 6, 21, and 22 were selected. 90 samples of unrelated individuals from two human populations, African-Americans and Caucasians, were genotyped utilizing 5′ nuclease assays that are commercially available as part of a genome-wide set. The empirical results of this comparative study of LD across the three chromosomes and two populations studied are described: blocks with strong LD and low haplotype diversity are identified using a variety of algorithms, the characteristics of those blocks as well as the robustness of the different haplotype block definitions are analyzed, and metric maps for describing regional differences in LD and for guiding SNP selection for association studies are described. Finally, the results of haplotype-based power calculations for case-control studies are presented across the gene-spanning regions of these three chromosomes to better understand the utility of the SNP set examined here.

The TaqMan® probe-based, 5′ nuclease assays, were utilized to genotype 19,860 SNPs selected from the Celera Human RefSNP database (v 3.6) in 45 African-American and 45 Caucasian DNA samples from the Coriell Institute/NIGMS Human Variation panels. Those assays are commercially available as part of Applied Biosystems' Assays-on-Demand™ SNP Genotyping Products. All SNPs had heterozygosity greater than 0.1 in the respective population, and were tested for deviation of Hardy-Weinberg Equilibrium (p<0.001). In some embodiments, the SNP set covers a total of 193.6 Mb, or approximately 15% of the genome (75% of chromosome 6; 92% of chromosome 21; 89% of chromosome 22) without gaps greater than 60 kb. The mean SNP spacing ranges from 10.4 to 7.2 kb, whereas the median spacing ranges from 6.7 to 3.8 kb, indicating that for most covered segments there is high-resolution coverage.

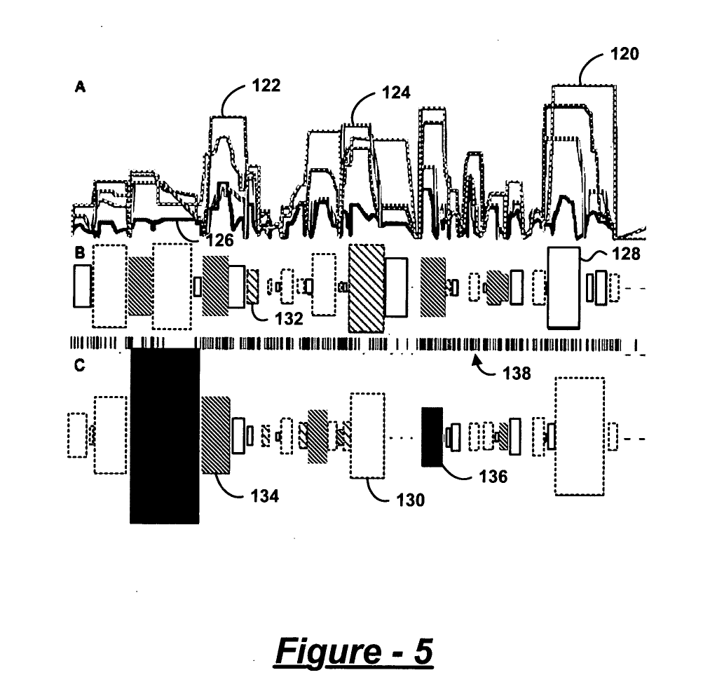

Identification and analysis of haplotype blocks can be accomplished by implementing several methods to identify segments of strong LD and low haplotype diversity (i.e. “haplotype blocks”) For example, the |D′| method of Gabriel et al. (Science 296:2225-9, 2002), the four-gamete rule, and an alternative method based on hypothesis testing using |D′| performed at two p-value thresholds of 0.05 and 0.001. One skilled in the art will appreciate that there are other methods for computing LD and haplotype blocks. Grouping SNPs into haplotype blocks by any method can yield several alternative partitions. For example, turning to FIG. 5, if the |D′| method rules are applied sequentially moving in one direction along the chromosome, a block partition is found that is different than that obtained by moving in the opposite direction (see panels B and C); neither of these two partitions is necessarily optimal. Therefore, some embodiments, employ, a dynamic programming algorithm to partition the SNPs into a minimum number of blocks. In one case, multiple optimal solutions were obtained, and while overlapping, they differed up to 37% in the location of boundaries. When comparing different methods, the differences in shared boundaries are more dramatic, although again significant overlap exists. FIG. 5 (panel A) depicts a visual representation of the variability in 100 different runs of the dynamic programming algorithm for each method in a 4 Mb segment of chromosome 22.

In particular, FIG. 5 illustrates concordance between different haplotype block finding methods as follows: panel A is a visualization summarizing the block partitions generated by 100 runs of the dynamic programming implementation of four block finding methods including the |D′| method as at 120, a hypothesis testing method for |D′| using p<0.005 as at 122; the same previous method with p<0.001 as at 124; and the four gamete test as at 126, and all runs for each method are averaged so that the height of the lines is proportional to the probability that each site is participating in a block, scaled by the number of SNPs in each block; panel B is a visualization of the haplotype blocks identified when the |D′| method of Gabriel et al. is applied in a sequential fashion, starting from the q-telomere. The height of the boxes representing each block is proportional to its physical length, and varying display properties represent haplotype diversity as measured by the Shannon Entropy using a scale going from low entropy blocks 128 (i.e., a few dominant common haplotypes), to high entropy blocks 136 (i.e., many haplotypes with evenly distributed population frequencies), with diversity values therebetween illustrated in order of increasing diversity as at blocks 130, 132, and 134 (if a color spectrum were used with blocks 128 being blue and blocks 136 being red, then blocks 130, 132, and 134 would respectively be green, yellow, and orange blocks); panel C illustrates that when the |D′| method is applied sequentially, this time moving from the p-telomere, a different albeit overlapping block partition is obtained, with tick marks 138 representing the SNPs typed in the region.

Construction of LD maps is now described. The description of LD patterns using the haplotype block paradigm does not fully describe the extent of LD that is useful for mapping in the greater than 50% of chromosomal intervals not encompassed by blocks in study described. An alternative approach to describe the local patterns of LD is to calculate the metric linkage disequilibrium units (LDUs) between pairs of SNPs developed by Maniatis et al. (PNAS 99: 2228-33, 2002). These units are additive and provide a coordinate system whose scale is proportional to the regional differences in the strength of LD, in a fashion analogous to the recombination maps constructed in cM used to guide linkage studies.

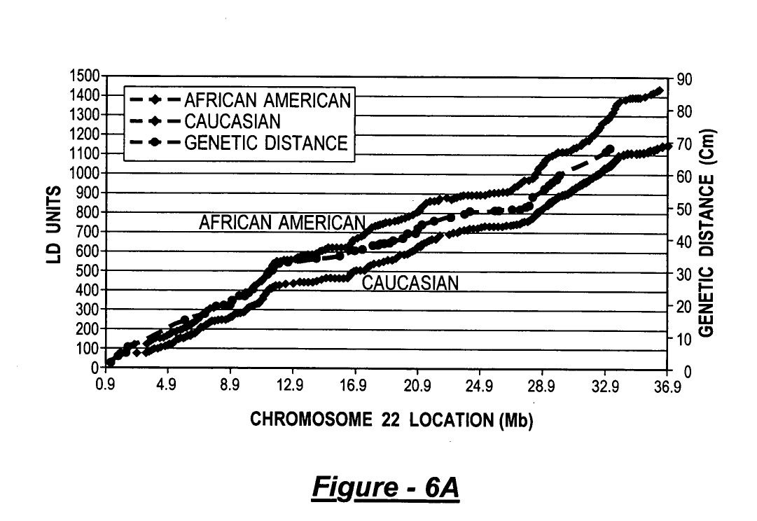

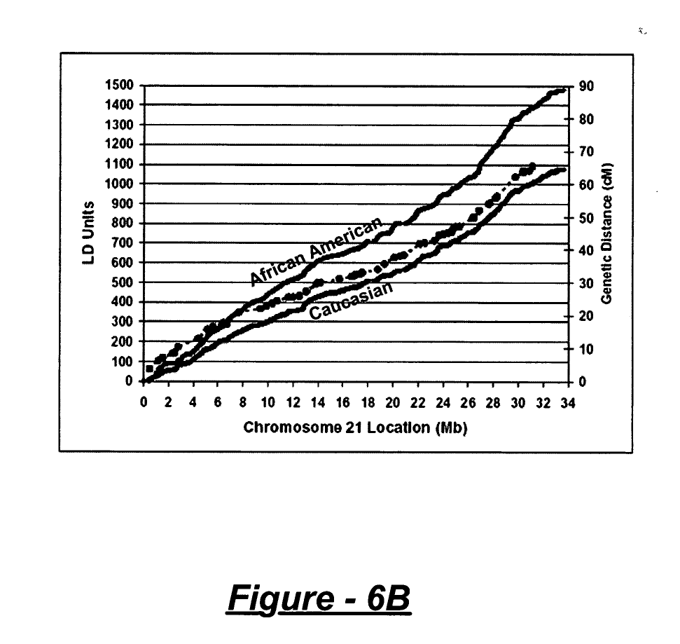

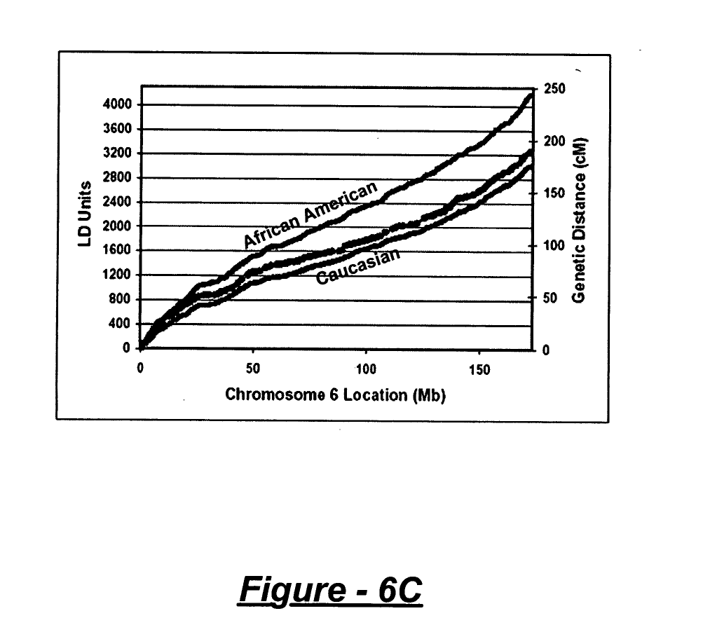

Turning now to FIGS. 6A, 6B, and 6C, LD maps of chromosomes 22, 21, and 6 for the African-American and Caucasian populations are provided. Locations of SNPs in LDUs (left vertical axis) are plotted versus physical location in Mb (horizontal axis). The upper line is an LD map for African-Americans. The lower line is an LD map for Caucasians. The middle line illustrates location of the markers part of the high-resolution linkage map of Kong et al. in the physical and the genetic maps (cM scale, right vertical axis).

The LDU scale can be useful in that the relationships between regions of low haplotype diversity (i.e., blocks) are specified in terms of map distance. These block regions are evident on the LD map scale but it is more important to determine the number of LDUs in a region since any two blocks, by any definition, may be in high LD with each other. Therefore, reliance on tagging haplotype blocks may be locally inefficient for determining optimal marker coverage. Also, the fraction of the genome in inter-block regions is not characterized in terms of haplotype blocks but rather in terms of LD map structure that can be determined fully given sufficient marker density. A remarkable property of the LDU maps for the two populations is that their overall contour is rather similar—most of the differences are found in the magnitude of the steps in regions of low LD/high recombination. This suggests that it may be possible to develop a ‘standard’ LD map that is efficient for association mapping in all populations if suitably scaled.

The power of the SNP set for association studies is now discussed. An important question is whether the marker density provides enough statistical power for association studies given the empirically observed LD profile. In the study described herein, the power for finding association across genes in the three chromosomes was calculated under a fixed sample size which is typical of these types of studies. A haplotype-based test and parameters compatible with the common variant/common disease hypothesis of complex disease were utilized, assuming disease allele frequencies of 0.1 or 0.2. To calculate power, each common haplotype inferred in a gene window was assumed to be in LD with the disease allele and a power value calculated. To provide a single power value per gene, an average weighted on the haplotype frequencies was computed. This average gives greater weight to the power estimated for the common haplotypes, and presumes that common haplotypes might be more likely to harbour more recent disease mutations.

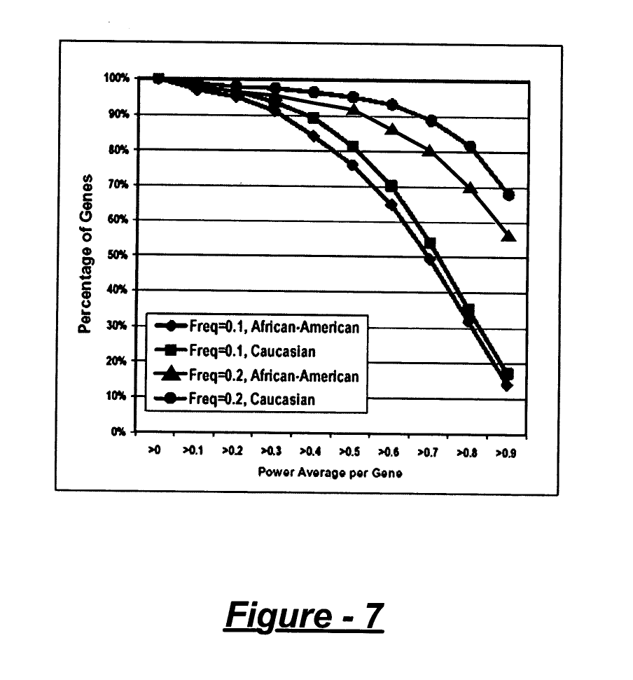

Turning now to FIG. 7, distribution of cumulative average power per gene is graphed, calculated for a fixed sample size of 500 cases and 500 controls. The power per gene was estimated for 1,004 genes. Each point shows the cumulative percentage of genes with a power greater or equal to each of the values on the horizontal axis. Power was calculated assuming disease allele frequencies of 0.1 or 0.2.

As described above, haplotype blocks for the entire length of three human autosomes were identified, and metric maps were constructed that are scaled to the strength of LD. The latter can guide the selection of SNPs for association studies independent of block boundaries. By all measures used, Caucasians showed about one-third more LD than African-Americans, and chromosome 6 exhibited up to 50% more LD than chromosomes 21 or 22. These results provide an empirical foundation for designing association studies, knowing in advance which genes have marker coverage likely to deliver adequate statistical power and which would require more SNPs and/or larger sample sizes.

FIGS. 8-15 illustrate the graphic user interface and complimentary visualization methodology according to the present innovation. FIG. 8 illustrates that the graphic user interface includes a chromosome selection drop down list 140 allowing the user select one of several viewable chromosomes, thus causing display of a chromosomal axis 154 representing the selected chromosome. Various reference markers are aligned in the active display respective of the chromosomal axis. For example, SNPs 142 are displayed in accordance with a mapping of SNP to chromosome location. African American haplotype blocks 144 and Caucasian haplotype blocks 146 are also displayed in appropriate locations. Gene regions 148 are further indicated, including forward strand 150 and reverse strand 152.

An unzoomed view after chromosome selection shows the entire chromosomal axis 154. The chromosomal axis is in units of base pairs, including multiples thereof, such as kilobase or other multiple of basepair units. The user can change the resolution by zooming in and out, and may be permitted to zoom in to a point where single basepair units are employed. Zooming can be achieved by a mouse left click. The zoomed view centers at the pointer location. A zoom out can be achieved by a right clicking, which can automatically adjust zoom and pan settings minimally to achieve “round numbers” for desired axis positions as further explained below.

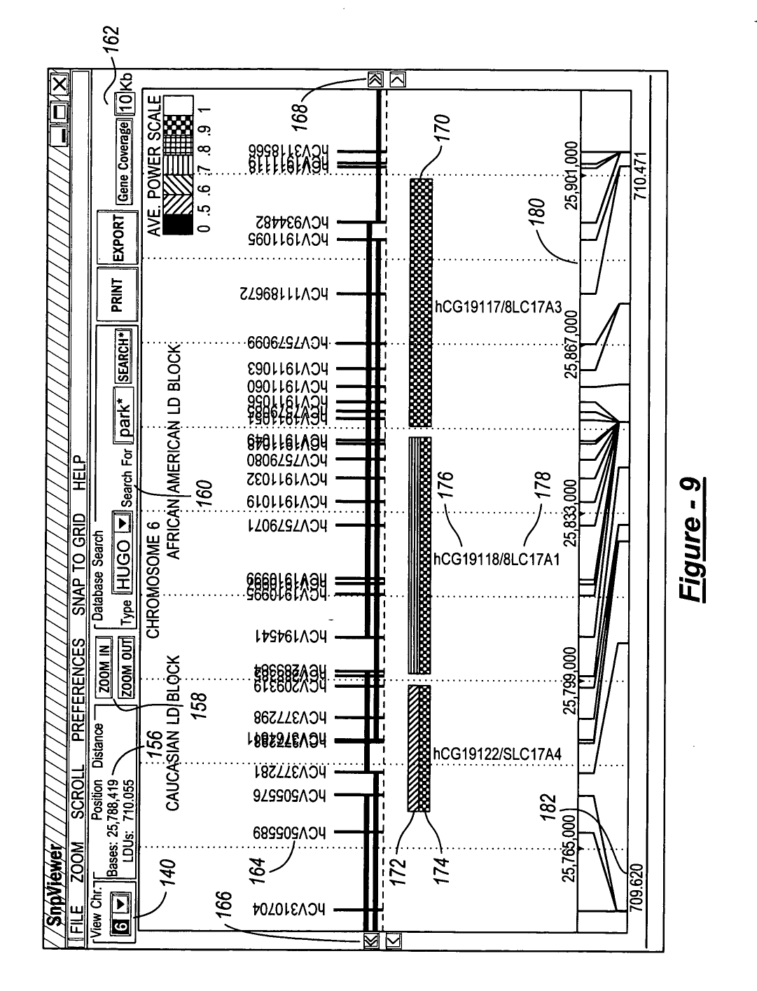

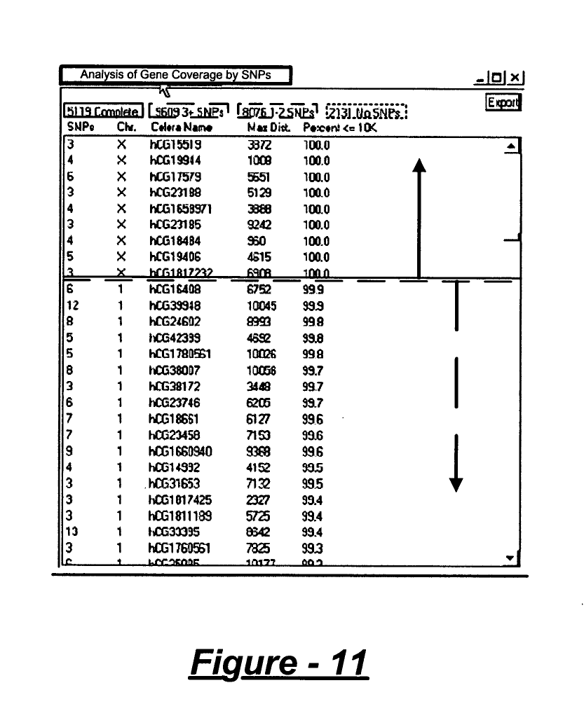

FIG. 9 illustrates additional components of the graphic user interface and accompanying methodology according to the present innovation. For example, next to the chromosome selection drop down list 140, a display control 156 communicates the pointer location to the user. Also, zoom buttons 158 allows the user to zoom in and out on the current center location without having to position the pointer. Further, search interface 160 allows the user to search by HUGO name or other name type. Yet further, gene coverage report button 162 allows the user to access a SNP coverage report as further discussed below with reference to FIG. 11. SNP ID 164 is still further displayed, and pan left button 166 and pan right button 168 allow the user to navigate the zoomed chromosome by panning left and right. Next to button 162, a text box allows the user to specify a degree of resolution for “Snap to Grid” functionality, which automatically adjusts zoom and pan settings minimally to achieve “round numbers” for desired axis positions. For example, if the user desires the grid lines to all fall on positions ending with 4 zeros, they select “Snap to Grid 10 K bases”. The viewer automatically zooms out the smallest amount possible to accommodate this request, while keeping the center of the view constant. Gene region 170 is still yet further displayed with a display property indicating its average power according to the average power scale in the upper right corner. These and other display properties are further discussed above with respect to FIG. 3. Returning to FIG. 9, upper and lower gene reference marker regions show different powers for African Americans 172 and Caucasians 174, and the gene ID 176 is co-displayed with the HUGO gene symbol 178. A physical scale 180 is provided in base pairs in correspondence with an LDU scale 182.

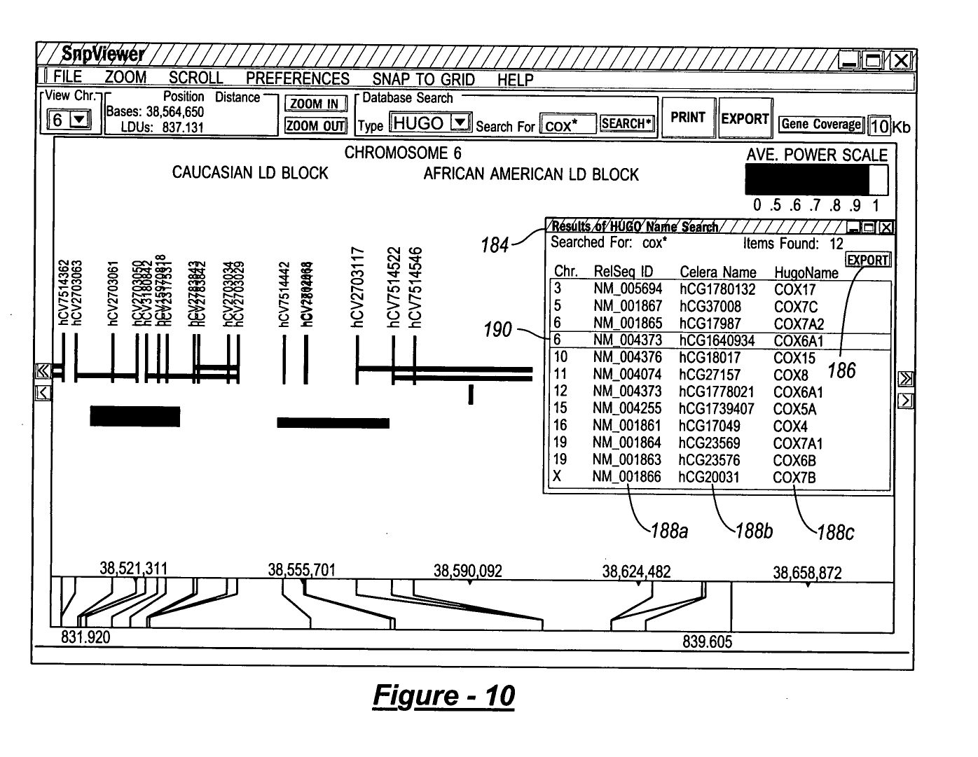

FIG. 10 illustrates a floating search results panel 184 that results when a user employs the search interface. A user can export search results by clicking on export button 186. Columns 188A, 188B, and 188C report different annotations, and clicking on an item 190 of the list changes focus of the active display to the specified gene region of the corresponding chromosome.

FIG. 11 illustrates an exemplary SNP coverage report showing the percent coverage based on a provided distance maximum in kb. The report shows the percentage of base pairs within each gene region where the distance is equal or less than the provided distance maximum. The report also shows the maximum distance between any given nucleotide on the gene region and a SNP marker. Gene region is defined as the span between the first and last transcribed base from a predicted gene. The list has a display criterion, such as background color, that codes grouped list elements by Mercury design criteria (“complete”=spacing markers <10 kb; 3 or more SNPs, 1-2 SNPs, No SNPs,), but can be replaced by other threshold by entering in the top right corner of the main viewer window.

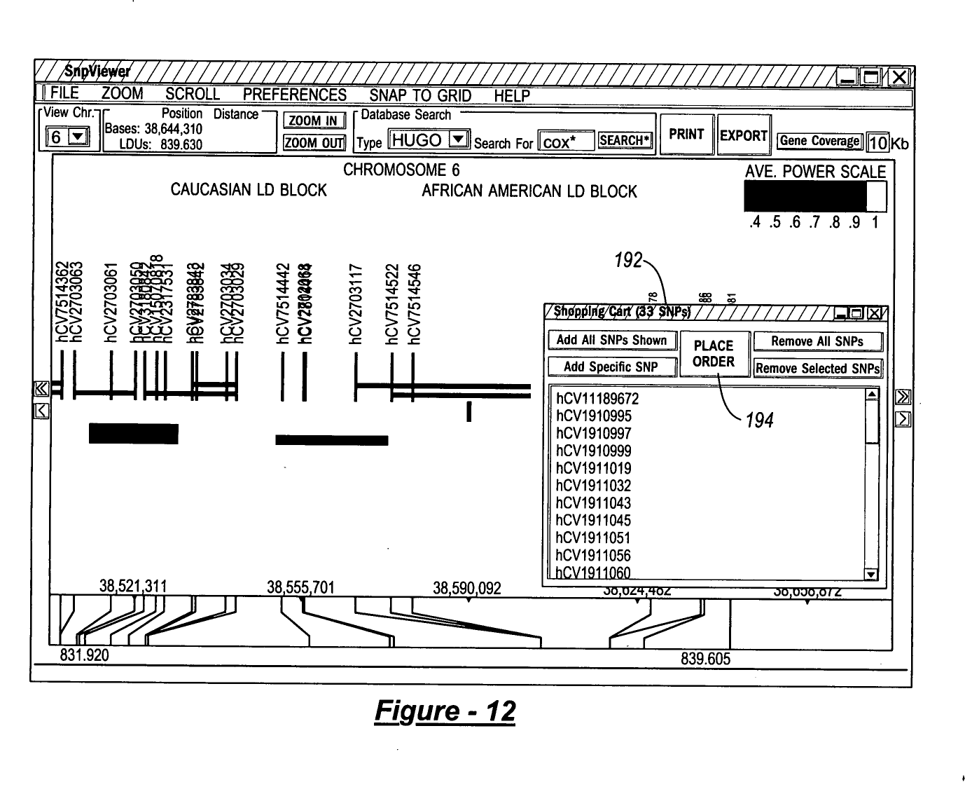

FIG. 12 illustrates an export window 192 accessible by one or more command buttons of the interface. Export window 192 can add all SNPs in view or specific SNPs. This list can be cut and pasted to other applications. Also, the user can click place order button 194 to automatically upload the SNP IDs to the AB store by opening a new Internet Explorer browser and performing a search for available AoD assays matching the list of SNP IDs in accordance with the available online store discussed with reference to FIG. 4. Subsequently, the user can add these assays to a shopping basket and place an order.

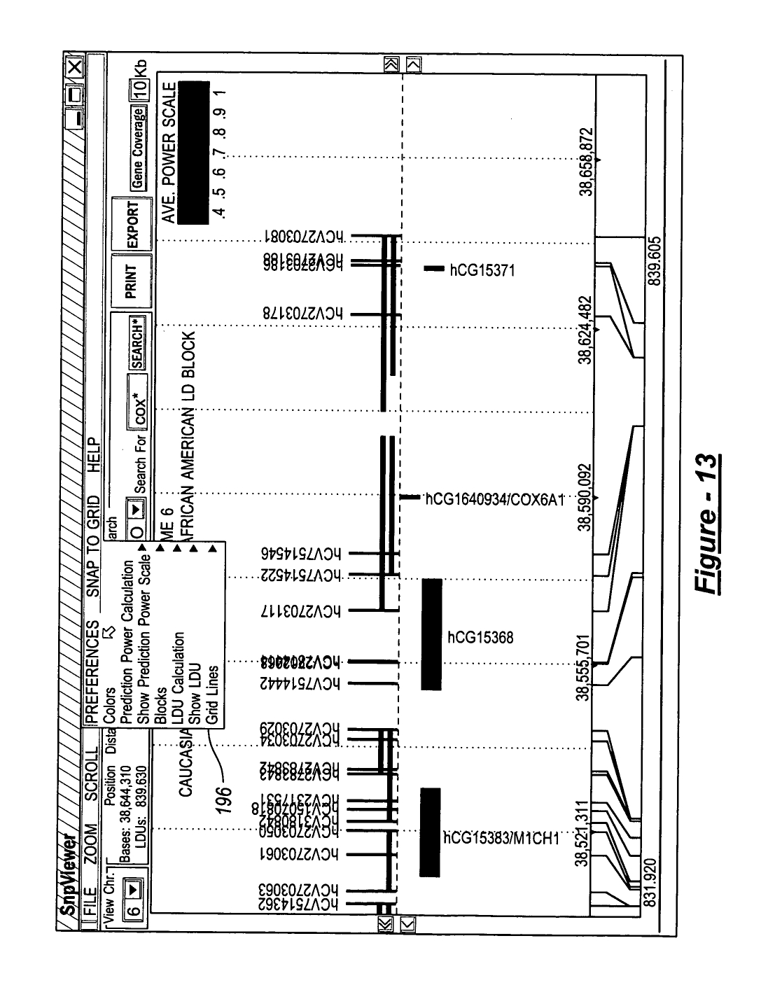

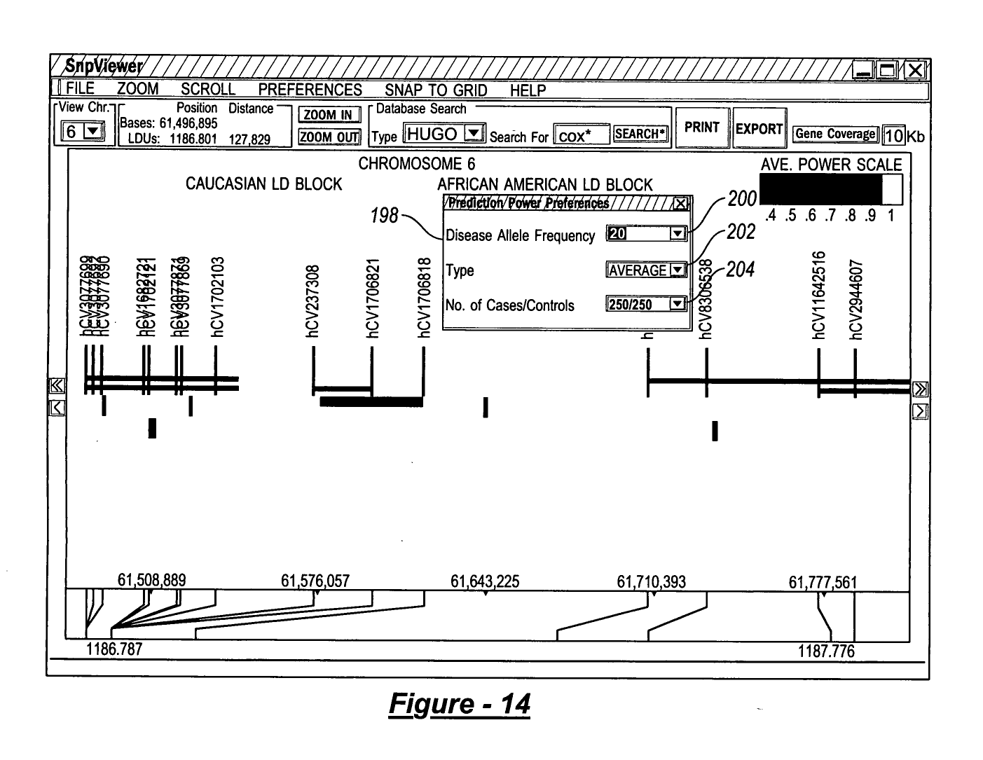

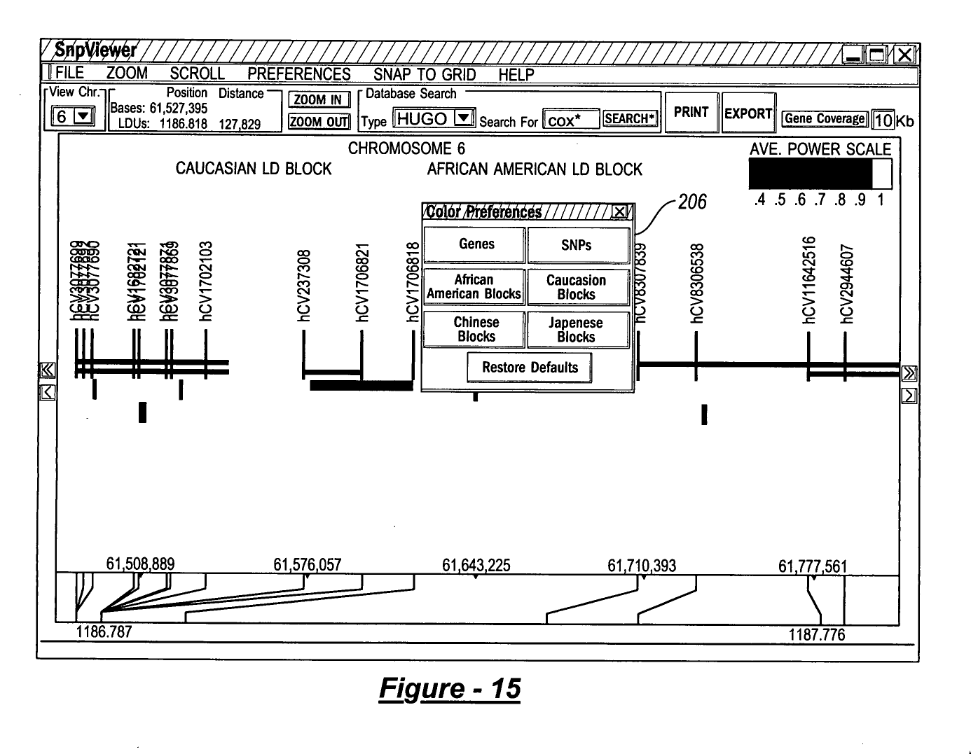

FIG. 13 illustrates a preferences menu 196. For example, the user may access controls for specifying preferences respective of power calculation parameters as further discussed below with reference to FIG. 14. The user may also access controls for specifying preferences respective of display properties, such as color, as further discussed below with reference to FIG. 15. Further, the user may toggle on/off power scale, specify blocks for different populations, adjust the LDU coordinate axis, and edit grid lines.

FIG. 14 illustrates a preferences panel 198 for power calculation for a fixed sample size. For example, an assumed disease allele frequency drop down list box 200 is provided for adjusting the assumed frequency. Also, an average type for D′ in gene region drop down list box 202, and a power for a fixed sample size of # cases/# controls drop down list box 204 permit adjustment of these parameters.

FIG. 15 illustrates a control preference panel 206 that allows change of display properties for genes, SNPs, and haplotype blocks for each population. Display properties, such as colors for different types of reference markers, can therefore be selected. The name of the marker type may then be displayed in view according to or in association with the display property to facilitate user interpretation as illustrated in FIG. 3. Color is preferred as a display property, but graph pattern may also be used.

Those skilled in the art can now appreciate from the foregoing description that these broad teachings can be implemented in a variety of forms. Therefore, while the teachings have been described in connection with particular examples thereof, the true scope thereof should not be so limited since other modifications will become apparent to the skilled practitioner upon a study of the drawings, the specification and the following claims.

1. A method for displaying genomic information, comprising:
displaying a first axis representing a chromosome with units of basepairs;
displaying on said first axis a first set of gene reference marks identifying genes located on the forward strand of said chromosome;
displaying on said first axis a second set of gene reference marks identifying genes located on the reverse strand of said chromosome;
displaying one or more sets of genetic marker reference marks; and
displaying one or more sets of haplotype reference marks wherein each set identifies one or more haplotype blocks for a population.

2. The method of claim 1 wherein the first set of gene reference marks identifying the genes on the forward strand of said chromosome indicate intron and exon regions for one of more genes in the set.

3. The method of claim 1 wherein the second set of gene reference marks identifying the genes on the reverse strand of said chromosome indicate intron and exon regions for one of more genes in the set.

4. The method of claim 3 wherein said exon regions are encoded with prediction power information for one or more populations.

5. The method of claim 4 wherein the prediction power information is calculated via a statistical model.

6. The method of claim 1 further comprising,
displaying a second axis with units of linkage disequilibrium;
selecting a population; and
providing links between said first axis and said second axis that indicate the location of the genetic marker reference marks for the selected population.

7. The method of claim 1 wherein the genetic marker reference marks correspond to single-nucleotide polymorphisms.

8. The method of claim 7, further comprising providing a selection mechanism whereby a user may select displayed genetic marker reference marks and automatically query an online ordering system for assays based on corresponding single-nucleotide polymorphisms.

9. The method of claim 1, further comprising providing a navigation mechanism whereby a user may select a chromosome for display and navigate the genomic information by navigating an active display of the chromosome.

10. The method of claim 9, further comprising panning and zooming the active display of the chromosome in response to pan and zoom navigation selections.

11. A graphic user interface for displaying genomic information, comprising:
a navigation mechanism whereby a user may access a datastore of genomic information by navigating an active display of the chromosome,
wherein the active display of the chromosome includes a first axis representing the chromosome with units of basepairs, a first set of gene reference marks displayed on the first axis and identifying genes located on the forward strand of said chromosome, a second set of gene reference marks displayed on the first axis and identifying genes located on the reverse strand of said chromosome, one or more sets of genetic marker reference marks, and one or more sets of haplotype reference marks wherein each set identifies one or more haplotype blocks for a population.

12. The graphic user interface of claim 11 wherein the first set of gene reference marks identifying the genes on the forward strand of said chromosome indicate intron and exon regions for one of more genes in the set.

13. The graphic user interface of claim 11 wherein the second set of gene reference marks identifying the genes on the reverse strand of said chromosome indicate intron and exon regions for one of more genes in the set.

14. The graphic user interface of claim 13 wherein said exon regions are encoded with prediction power information for one or more populations.

15. The graphic user interface of claim 14 wherein the prediction power information is calculated via a statistical model.

16. The graphic user interface of claim 11, wherein the active display of the chromosome further includes a second axis with units of linkage disequilibrium, a population selection mechanism, and a display property providing links between said first axis and said second axis that indicate the location of the genetic marker reference marks for the selected population.

17. The graphic user interface of claim 11 wherein the genetic marker reference marks correspond to single-nucleotide polymorphisms.

18. The graphic user interface of claim 17, further comprising a selection mechanism whereby a user may select displayed genetic marker reference marks and automatically query an online ordering system for assays based on corresponding single-nucleotide polymorphisms.

19. The graphic user interface of claim 11, wherein said navigation mechanism permits a user to select a chromosome for display.

20. The graphic user interface of claim 19, wherein said navigation mechanism is adapted to pan and zoom the active display of the chromosome in response to pan and zoom navigation selections.
